(19) United States
(12) Patent Application Publication
(10) Pub. No.: US 2009/0207913 A1
(43) Pub. Date: Aug. 20, 2009

(54) METHOD AND APPARATUS FOR ENCODING AND DECODING IMAGE

(75) Inventors: Duck-yeon KIM, Yongin-si (KR); Bae-keun LEE, Bucheon-si (KR); Kyo-hyuk LEE, Yongin-si (KR); Woo-jin HAN, Suwon-si (KR); Sang-rae LEE, Suwon-si (KR); Jae-chool LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/389,776

(22) Filed: Feb. 20, 2009

(30) Foreign Application Priority Data
Feb. 20, 2008 (KR) 10-2008-0015452

(51) Int. Cl. H04N 7/32

(52) U.S. Cl. 375/240.12; 375/E07.243

(57) ABSTRACT

Provided are methods and apparatuses for encoding an image and methods and apparatuses for decoding an image. The methods and apparatuses generate a compensated prediction block by compensating a prediction block of a current block by using a predetermined compensation value and encode a residual value that is a difference between the compensated prediction block and an input current block.

### CROSS-REFERENCE TO RELATED PATENT APPLICATION

This application claims priority from Korean Patent Application No. 10-2008-0015452, filed on Feb. 20, 2008 in the Korean Intellectual Property Office, the disclosure of which is incorporated herein in its entirety by reference.

### BACKGROUND OF THE INVENTION

1. Field of the Invention

Methods and apparatuses consistent with the present invention relate encoding and decoding an image, and more particularly, to compensating a prediction signal of an input image and encoding a difference between the compensated prediction signal and an original input signal.

2. Description of the Related Art

In image compression schemes, such as Moving Picture Experts Group (MPEG)-1, MPEG-2, MPEG-4, and H.264/MPEG-4 Advanced Video Coding (AVC), pictures are divided into macroblocks to encode images. Each of the macroblocks is subjected to inter-prediction or intra-prediction by using all possible encoding modes. Thereafter, one of these encoding modes is selected to encode each macroblock according to a bit rate required for macroblock encoding and according to a distortion degree between a decoded macroblock and an original macroblock.

In intra-prediction, a prediction value of a current block to be encoded is calculated by using pixel values of pixels located around the current block, and a difference between the prediction value and an actual pixel value of the current block is encoded. In inter-prediction, a motion vector is generated by searching for a region that is similar to the current block to be encoded in at least one reference picture that precedes or follows the current picture to be encoded and a differential value between the current block and a prediction block generated by motion compensation using the generated motion vector is encoded.

In the related art, either intra-prediction or inter-prediction is used to generate a prediction block corresponding to a current block, and a cost is then calculated by using a predetermined cost function. Thereafter, the encoding mode having the lowest cost is selected to perform encoding, which leads to improved compression efficiency.

However, to overcome limited transmission bandwidth and to provide high quality images, there is an ongoing demand for an improved method of encoding an image which has even more compression efficiency.

### SUMMARY OF THE INVENTION

The present invention provides a method and apparatus for encoding an image, which can improve prediction efficiency and a peak signal to noise ratio (PSNR) by compensating a prediction block of a current block to be encoded by using an average value of pixels included in an input current block, an average value of pixels included in previous pictures that are previously encoded and restored, or an average value of pixels included in predictive pictures of previous pictures.

According to an aspect of the present invention, there is provided a method of encoding an image, the method comprising: generating a prediction block for a current block; calculating a compensation value that is a difference between an average value of pixels in the current block and an average value of pixels in the prediction block; compensation the prediction block by using the compensation value; and encoding a difference value between the compensated prediction block and the current block.

According to another aspect of the present invention, there is provided an apparatus for encoding an image, the apparatus comprising: a prediction unit generating a prediction block for a current block; a compensation value calculation unit calculating a compensation value that is a difference between an average value of pixels in the current block and an average value of pixels in the prediction block; a prediction block compensation unit compensation the prediction block by using the compensation value; and an encoding unit encoding a difference value between the compensated prediction block and the current block.

According to another aspect of the present invention, there is provided a method of encoding an image, the method comprising: calculating a compensation value that is a difference between an average value of pixels included in a predictive picture of at least one previous picture and an average value of pixels included in a restored previous picture that is obtained by encoding and restoring the previous picture; generating prediction blocks for macroblocks of a current picture; compensation the prediction blocks of the macroblocks of the current picture by using the compensation value; and encoding a difference value between the compensated prediction blocks of the macroblocks and the macroblocks of the current picture.

According to another aspect of the present invention, there is provided an apparatus for encoding an image, the apparatus comprising: a predictive picture storage unit storing a predictive picture of at least one previous picture; a restored picture storage unit storing a restored picture that is obtained by encoding and restoring each picture included in an input image; a compensation value calculation unit calculating a compensation value that is a difference between an average value of pixels included in the previous picture of the at least one previous picture and an average value of pixels included in a restored previous picture that is obtained by encoding and restoring the previous picture; a prediction unit generating prediction blocks for macroblocks of a current picture; a prediction block compensation unit compensation the prediction blocks of the macroblocks of the current picture by using the compensation value; and an encoding unit encoding a difference value between the compensated prediction blocks of the macroblocks and the macroblocks of the current picture.

According to another aspect of the present invention, there is provided a method of encoding an image, the method comprising: calculating a compensation value that is a difference between an average value of pixels included in a restored previous picture that is obtained by encoding and restoring at least one previous picture and an average value of pixels included in an input previous picture; generating prediction blocks of macroblocks of a current picture; compensation the prediction blocks of the macroblocks of the current picture by using the compensation value; and encoding a difference value between the compensated prediction blocks of the macroblocks and the macroblocks of the current picture.

According to another aspect of the present invention, there is provided an apparatus for encoding an image, the apparatus comprising: a restored picture storage unit storing a restored picture that is obtained by encoding and restoring each picture included in an input image; a compensation value calculation unit calculating a compensation value that is a difference between an average value of pixels included in at least one restored previous picture and an average value of pixels included in an input previous picture; a prediction unit generating prediction blocks for macroblocks of a current picture; a prediction block compensation unit compensation the prediction blocks of the macroblocks of the current picture by using the compensation value; and an encoding unit encoding a difference value between the compensated prediction blocks of the macroblocks and the macroblocks of the current picture.

According to another aspect of the present invention, there is provided a method of encoding an image, the method comprising: calculating a compensation value that is a difference between an average value of pixels included in a restored current picture that is obtained by encoding and restoring a current picture and an average value of pixels included in an input current picture; generating prediction blocks for macroblocks of the current picture; compensation the prediction blocks of the macroblocks of the current picture by using the compensation value; and encoding a difference value between the compensated prediction blocks of the macroblocks and the macroblocks of the current picture.

According to another aspect of the present invention, there is provided an apparatus for encoding an image, the apparatus comprising: a prediction unit generating prediction blocks for macroblocks of a current picture; an encoding unit encoding a difference value between each of the prediction blocks and an input macroblock; a restoration unit restoring the encoded current picture; a compensation value calculation unit calculating a compensation value that is a difference between an average value of pixels included in the restored current picture and an average value of pixels included in an input current picture; and a prediction block compensation unit compensation the prediction blocks of the macroblocks of the current picture by using the compensation value, wherein the encoding unit encodes a difference value between the compensated prediction blocks of the macroblocks and the macroblocks of the current picture to generate a final bitstream.

According to another aspect of the present invention, there is provided a method of decoding an image, the method comprising: extracting from an input bitstream a prediction mode of a current block to be decoded and information on an absolute value and a sign of a compensation value used when compensating for a prediction block of the current block; generating the prediction block of the current block according to the extracted prediction mode; compensation the prediction block by using the compensation value; and restoring the current block by adding the compensated prediction block and a residual value of the current block which is extracted from the bitstream.

According to another aspect of the present invention, there is provided an apparatus for decoding an image, the apparatus comprising: an entropy decoding unit extracting from an input bitstream a prediction mode of a current block to be decoded and information on an absolute value and a sign of a compensation value used when compensating for a prediction block of the current block; a prediction unit generating the prediction block of the current block according to the extracted prediction mode; a prediction block compensation unit compensation the prediction block by using the compensation value; and an addition unit restoring the current block by adding the compensated prediction block and a residual value of the current block which is extracted from the bitstream.

According to another aspect of the present invention, there is provided a method of decoding an image, the method comprising: extracting from an input bitstream a prediction mode of each macroblock included in a current picture to be decoded and information on a sign of a compensation value used when compensating for a prediction block of the macroblock; calculating the compensation value by using a difference between an average value of pixels included in a predictive picture of at least one previous picture that is restored before the current picture and an average value of pixels included in a restored previous picture; generating prediction blocks of macroblocks of the current picture according to the extracted prediction mode; compensation the prediction blocks of the macroblocks of the current picture by using the compensation value and the information on the sign of the compensation value; and restoring the macroblocks of the current picture by adding the compensated prediction blocks of the macroblocks and a residual value included in the bitstream.

According to another aspect of the present invention, there is provided an apparatus for decoding an image, the apparatus comprising: an entropy decoding unit extracting from an input bitstream a prediction mode of each macroblock included in a current picture to be decoded and information on a sign of a compensation value used when compensating for a prediction block of the macroblock; a compensation value calculation unit calculating the compensation value by using a difference between an average value of pixels included in a predictive picture of at least one previous picture that is restored before the current picture and an average value of pixels included in a restored previous picture; a prediction unit generating prediction blocks for macroblocks of the current picture according to the extracted prediction mode; a prediction block compensation unit compensation the prediction blocks of the macroblocks of the current picture by using the compensation value and the information on the sign of the compensation value; and an addition unit restoring the macroblocks of the current picture by adding the compensated prediction blocks of the macroblocks and a residual value included in the bitstream.

### BRIEF DESCRIPTION OF THE DRAWINGS

The aspects of the present invention will become more apparent by describing in detail exemplary embodiments thereof with reference to the attached drawings in which:

FIG. 1 is a block diagram of an apparatus for encoding an image according to a first exemplary embodiment of the present invention;

FIG. 2 is a flowchart illustrating a method of encoding an image according to the first exemplary embodiment of the present invention;

FIG. 3 is a block diagram of an apparatus for encoding an image according to a second exemplary embodiment of the present invention;

FIG. 4 is a flowchart illustrating a method of encoding an image according to the second exemplary embodiment of the present invention;

FIG. 5A is a reference view illustrating compensation values applied to prediction blocks of macroblocks of a current picture according to an exemplary embodiment of the present invention;

FIG. 5B is a reference view illustrating information on signs of the compensation values applied to the prediction blocks of the macroblocks of the current picture of FIG. 5A according to an exemplary embodiment of the present invention;

FIG. 6 is a flowchart illustrating a method of encoding an image according to a third exemplary embodiment of the present invention;

FIG. 7 is a flowchart illustrating a method of encoding an image according to a fourth exemplary embodiment of the present invention;

FIG. 8 is a block diagram of an apparatus for decoding an image according to the first exemplary embodiment of the present invention;

FIG. 9 is a flowchart illustrating a method of decoding an image according to the first exemplary embodiment of the present invention;

FIG. 10 is a block diagram of an apparatus for decoding an image according to the second exemplary embodiment of the present invention; and

FIG. 11 is a flowchart illustrating a method of decoding an image according to the second exemplary embodiment of the present invention.

### DETAILED DESCRIPTION OF EXEMPLARY EMBODIMENTS OF THE INVENTION

Exemplary embodiments of the present invention will now be described more fully with reference to the accompanying drawings.

The present invention generates a compensated prediction block by compensating a prediction block of a current block which is generated by performing intra-prediction or inter-prediction by using a predetermined compensation value, and encodes a residual value that is a difference between the compensated prediction block and an input current block. The exemplary embodiments of the present invention use as a compensation value for compensating a prediction block of a current block any one of a difference (i) between an average value of pixels of an input current block and an average value of pixels of a prediction block, a difference (ii) between an average value of pixels included in a predictive picture of at least one previous picture and an average value of pixels included in a previous picture that is encoded and then restored, a difference (iii) between an average value of pixels included a predictive picture of at least one previous picture and an average value of pixels included in an original previous picture, and a difference (iv) between an average value of pixels included in a restored current picture that is obtained by encoding and restoring a current picture and an average value of pixels included in an input current picture. The exemplary embodiments of the present invention which compensate for a prediction block of a current block by using one of the differences (i) through (iv) as a compensation value will now be explained in detail.

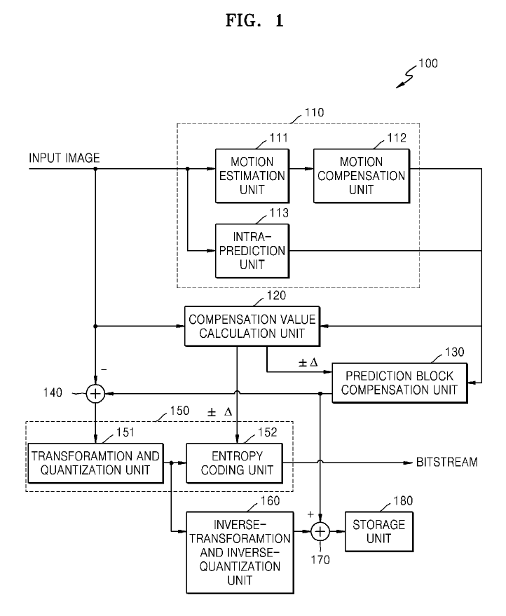

FIG. 1 is a block diagram of an apparatus 100 for encoding an image according to a first exemplary embodiment of the present invention.

Referring to FIG. 1, the apparatus 100 includes a prediction unit 110, which includes a motion prediction unit 111, a motion compensation unit 112, and an intra-prediction unit 113, a compensation value calculation unit 120, a prediction block compensation unit 130, a subtraction unit 140, an encoding unit 150, which includes a transformation and quantization unit 151 and an entropy coding unit 152, an inverse-transformation and inverse-quantization unit 160, an addition unit 170, and a storage unit 180.

The prediction unit 110 divides an input image into blocks each having a predetermined size, and generates a prediction block for each of the divided blocks by performing inter-prediction or intra-prediction. In detail, the motion prediction unit 111 performs motion prediction to generate a motion vector by searching for a region that is similar to a current block within a predetermined search range of a reference picture that is previously encoded and then restored. The motion compensation unit 112 performs inter-prediction through motion compensation to generate a prediction block of the current block by acquiring region data of the reference picture indicated by the generated motion vector. The intra-prediction unit 113 performs intra-prediction to generate a prediction block by using data of neighboring blocks around the current block. The inter-prediction and the intra-prediction may be performed in modes defined in an image compression standard, such as the H.264 standard, or in other modified modes.

The compensation value calculation unit 120 generates a compensation value by calculating a difference between an average value of pixels of an input current block and an average value of pixels of the prediction block. For example, if an average value of pixels included in the current block is MC and an average value of pixels included in the prediction block is MP, the compensation value calculation unit 120 generates a compensation value MC-MP that is a difference between the average value MC and the average value MP.

The prediction block compensation unit 130 generates a positive compensation value +Δ by multiplying an absolute value Δ of the compensation value by +1 and generates a negative compensation value −Δ by multiplying the absolute value Δ of the compensation value by −1, and compensates the prediction block by adding one of the positive compensation value +Δ and the negative compensation value −Δ to each pixel of the prediction block of the current block. One of the positive compensation value +Δ and the negative compensation value −Δ, which is to be applied to the prediction block of the current block, may be selected by generating compensated prediction blocks by applying the positive compensation value +Δ and the negative compensation value −Δ to the prediction block of the current block, comparing costs, e.g., rate-distortion (RD) costs, incurred when the prediction blocks generated by using the positive compensation value +Δ and the negative compensation value −Δ are encoded, and determining the compensation value having the lower cost as a compensation value to be applied to the prediction block of the current block. Alternatively, the prediction block compensation unit 130 may compensate the prediction block by using the positive compensation value +Δ when the average value MC of the pixels included in the current block is greater than the average value MP of the pixels included in the prediction block, and by using the negative compensation value −Δ when the average MC of the pixels included in the current block is less than the average value MP of the pixels included in the prediction block.

The subtraction unit 140 calculates a prediction error by subtracting pixel values of the compensated prediction block from original pixel values of the current block. Hereinafter, the prediction error, which is a difference between the original pixel values and the pixel values of the compensated prediction block, will be referred to as a residue or a residual.

The transformation and quantization unit 151 performs frequency transformation on the residual and quantizes the transformed residual. The frequency transformation may be discrete cosine transformation (DCT).

The entropy coding unit 152 performs variable length coding on the quantized residual to generate a bitstream. The entropy coding unit 152 adds information on an absolute value and a sign of the compensation value used for the compensation of the prediction block to the bitstream generated by the variable length coding, such that an apparatus for decoding an image can generate a compensated prediction block by compensating a prediction block in the same manner as that used by the apparatus 100. Also, the entropy coding unit 152 adds predetermined binary information indicating whether the current block has been encoded by using the compensated prediction block to header information of an encoded block, such that the apparatus for decoding the image can determine whether it is necessary to compensate the prediction block of the current block. For example, assuming that one bit indicating that the current block is encoded by using the compensated prediction block is added to the bitstream, if ‘0’ is presented, it means that the block is encoded without any compensation of the prediction block according to the conventional art, and when ‘1’ is presented, it means that the block is encoded by using the compensated prediction block according to the exemplary embodiment of the present invention.

In order to efficiently transmit the information on the compensation value used for the compensation of the prediction block of the current block, the entropy coding unit 152 may previously store the compensation value in a predetermined variable length coding table, add information on the predetermined variable length coding table and predetermined index information on the compensation value of the prediction block to an encoded bitstream, and transmit the bitstream to which the information is added to the apparatus for decoding the image. If the apparatus 100 and the apparatus for decoding the image use the preset same variable length coding table for the compensation value, the entropy coding unit 152 does not need to transmit the variable length coding table, and thus may add the index information on the compensation value to the bitstream and transmit only the bitstream to which the index information is added. The entropy coding unit 152 may transmit the information on the compensation value by using fixed length coding in which fixed length bits are assigned according to compensation values in such a manner that a bit showing the highest overhead performance is assigned to a compensation value that is most often generated among compensation values generated while encoding the blocks of the input image.

The inverse-transformation and inverse-quantization unit 160 restores a residual by performing inverse-quantization and inverse-transformation on the quantized residual, and the addition unit 170 restores the current block by adding the restored residual and the compensated prediction block. The restored current block is stored in the storage unit 180, and is used to generate a prediction block of a next block.

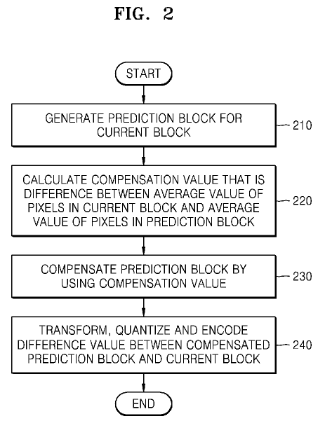

FIG. 2 is a flowchart illustrating a method of encoding an image according to a first exemplary embodiment of the present invention.

Referring to FIG. 2, in operation 210, inter-prediction or intra-prediction is performed on a current block to generate a prediction block of the current block.

In operation 220, a compensation value, which is a difference between an average value of pixels in the current block and an average value of pixels in the prediction block, is calculated.

In operation 230, the prediction block of the current block is compensated by using the compensation value. In detail, a positive compensation value obtained by multiplying an absolute value of the compensation value by +1 and a negative compensation value obtained by multiplying the absolute value of the compensation value by −1 are generated, and then one of the positive compensation value and the negative compensation value is added to each pixel of the prediction block of the current block to compensate the prediction block.

In operation 240, a residual, which is a difference value between the compensated prediction block and the current block, is transformed, quantized, and entropy encoded, to generate a bitstream. Information on the absolute value and sign of the compensation value used for the compensation of the prediction block of the current block may be added to the generated bitstream. The information on the absolute value and sign of the compensation value may be added to the bitstream by using variable length coding or fixed length coding and then transmitted to an apparatus for decoding an image.

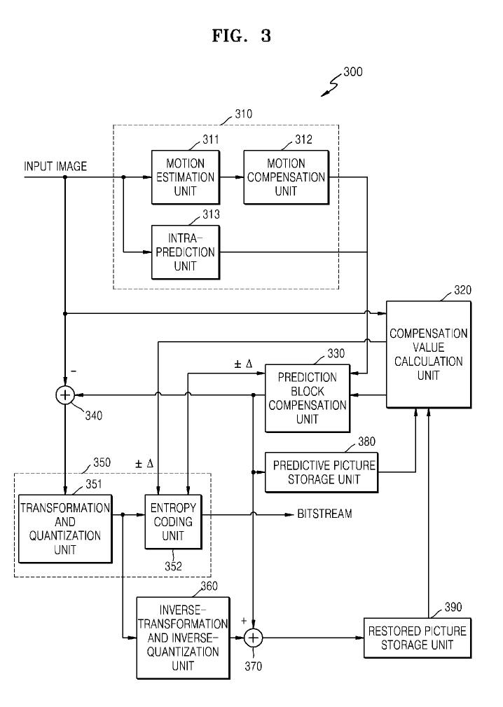

FIG. 3 is a block diagram of an apparatus 300 for encoding an image according to a second exemplary embodiment of the present invention.

The apparatus of FIG. 300 according to the second exemplary embodiment of the present invention is similar in operation and configuration to the apparatus 100 of FIG. 1 according to the first exemplary embodiment of the present invention. However, the apparatus 100 of FIG. 1 uses the difference between the average value of the pixels in the current block and the average value of the pixels in the prediction block as the compensation value for the compensation of the prediction block of the current block, while the apparatus 300 of FIG. 3 uses a difference between an average value of pixels included in a predictive picture of at least one previous picture and an average value of pixels included in an encoded and restored previous picture as a compensation value.

Referring to FIG. 3, the apparatus 300 includes a prediction unit 310, which includes a motion prediction unit 311, a motion compensation unit 312, and an intra-prediction unit 313, a compensation value calculation unit 320, a prediction block compensation unit 330, a subtraction unit 340, an encoding unit 350, which includes a transformation and quantization unit 351 and an entropy coding unit 352, an inverse-transformation and inverse-quantization unit 360, an addition unit 370, a predictive picture storage unit 380, and a restored picture storage unit 390.

The prediction unit 310 divides an input image into macroblocks, and generates a prediction block for each divided macroblock by performing inter-prediction or intra-prediction.

The predictive picture storage unit 380 stores a predictive picture obtained by predicatively encoding each picture included in the input image. The restored picture storage unit 390 stores a restored picture obtained by predictive encoding and restoring each picture of the input image. A predictive picture of at least one previous picture stored in the predictive picture storage unit 380, and a restored picture that is obtained by encoding and restoring the at least one previous picture stored in the restored picture storage unit 390 are output to the compensation value calculation unit 320.

The compensation value calculation unit 320 generates a compensation value by calculating a difference between an average value of pixels included in the predictive picture of the at least one previous picture which is encoded and restored before the current picture, and an average value of pixels included in the restored previous picture. For example, when n input previous pictures that are encoded before the current picture are Oi (where n is a positive integer and i ranges from 1 to n), a predictive picture for each previous picture Oi is Pi, and a restored previous picture that is obtained by transforming, quantizing, and entropy encoding a difference value between the input previous picture Oi and the predictive picture Pi, and then restoring the encoded difference value by performing inverse-quantization and inverse-transformation, is Oi′, the compensation value calculation unit 320 generates a compensation value by calculating a difference value between an average value of pixels included in the predictive pictures Pi of the n previous pictures and an average value of pixels included in the restored previous pictures Oi′.

The prediction block compensation unit 330 generates a positive compensation value +Δ by multiplying an absolute value Δ of the compensation value by +1 and generates a negative compensation value −Δ by multiplying the absolute value Δ of the compensation value by −1, and compensates for prediction blocks of the macroblocks by adding one of the positive compensation value +Δ and the negative compensation value −Δ to pixels of the prediction blocks of the macroblocks of the current picture. The prediction block compensation unit 330 may individually select the positive compensation value +Δ or the negative compensation value −Δ for each macroblock of the current block.

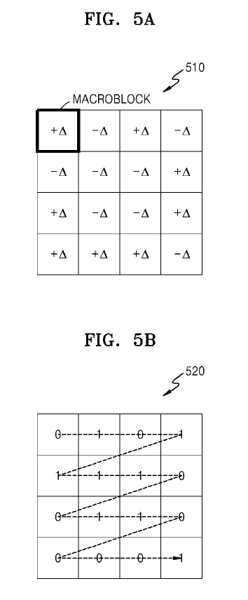

FIG. 5A is a reference view illustrating compensation values applied to prediction blocks of macroblocks of a current picture 510 according to an exemplary embodiment of the present invention. Referring to FIG. 5A, each of the prediction blocks of the macroblocks of the current picture 510 may be compensated by individually selecting one of the positive compensation value +Δ and the negative compensation value −Δ. In this case, in order to transmit information on a sign of a compensation value used for a prediction block of each macroblock of the current picture 510 to the apparatus for decoding the information, 1 bit is assigned to each macroblock as information on the sign of the compensation value.

FIG. 5B is a reference view illustrating information on signs of the compensation values applied to the prediction blocks of the macroblocks of the current picture 510 of FIG. 5A according to an exemplary embodiment of the present invention. Referring to FIG. 5B, when the positive compensation value +Δ is ‘0’ and the negative compensation value −Δ is ‘1’, information on the signs of the compensation values used in the compensation of the prediction blocks of the macroblocks included in the current picture 520 may be read out in a predetermined scanning order marked by an arrow in FIG. 5B, and then added to header information of a generated bitstream.

In order to select the compensation value used for the compensation of the prediction block of the current macroblock from among the positive compensation value and the negative compensation value, the prediction block compensation unit 330 may generate a compensated prediction block that is obtained by applying each of the positive compensation value and the negative compensation value to the prediction block of the current macroblock, compare costs incurred when the prediction blocks generated by using the positive and negative compensation values are encoded, and determine the compensation value with the lower cost as a compensation value to be applied to the prediction block of the current macroblock. A predictive picture including the compensated prediction blocks output from the prediction block compensation unit 330 is stored in the predictive picture storage unit 380 to generate a compensation value and then is output to the compensation value calculation unit 320.

The subtraction unit 340 generates a residual by subtracting the compensated prediction blocks from the current block. The transformation and quantization unit 351 performs frequency transformation and quantization on the residual.

The entropy coding unit 352 generates a bitstream by performing variable length coding on the quantized residual. The entropy coding unit 358 adds information on an absolute value and a sign of the compensation value used for the compensation of the prediction block to the bitstream generated by the various length coding. The apparatus 300 of FIG. 3 according to the second exemplary embodiment of the present invention may not transmit the information on the absolute value of the compensation value used for the compensation of the prediction block, but may add only the information on the sign of the compensation value to the bitstream and transmit the bitstream with the information on the sign of the compensation value. This is because the apparatus for decoding the image can extract the information on the absolute value of the compensation value by calculating the difference between the average value of the pixels included in the predictive picture of the at least one previous picture and the average value of the pixels included in the restored previous picture in the same manner as that used by the compensation value calculation unit 320 of FIG. 3 according to the second exemplary embodiment of the present invention.

The inverse-transformation and the inverse-quantization unit 360 restores the residual by performing inverse-quantization and inverse-transformation on the quantized residual, and the addition unit 370 restores the current block by adding the restored residual and the compensated prediction block. The restored current picture is stored in the restored picture storage unit 390 and is used to predict and compensate a next picture.

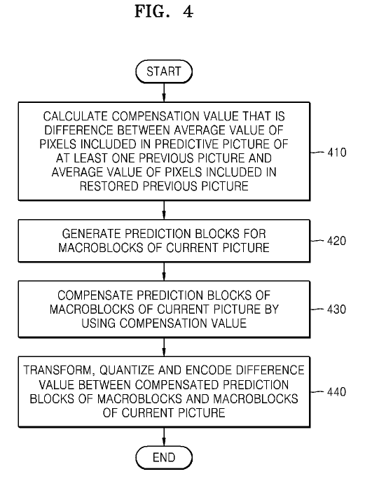

FIG. 4 is a flowchart illustrating a method of encoding an image according to the second exemplary embodiment of the present invention.

Referring to FIG. 4, in operation 410, a compensation value, that is a difference between an average value of pixels included in a predictive picture of at least one previous picture and an average value of pixels included in a restored previous picture that is obtained by encoding and restoring the previous picture, is calculated.

In operation 420, prediction blocks for macroblocks of a current picture are generated by performing intra-prediction or inter-prediction and a predictive picture of the current picture is generated.

In operation 430, the prediction blocks of the macroblocks of the current picture are compensated by using the compensation value. As described with reference to FIG. 5A, each of the macroblocks of the current picture may be individually compensated by selecting a positive compensation value or a negative compensation value. In this case, information on signs of the compensation values used for the macroblocks in addition to information on absolute values of the compensation values is transmitted as predetermined binary information. Since the apparatus for decoding the image, like the compensation value calculation unit 320 of FIG. 3 according to the second exemplary embodiment of the present invention, can extract the information on the absolute values of the compensation values by calculating a difference between the average value of the pixels included in the predictive picture of the at least one previous picture and the average value of the pixels included in the restored previous picture, only the information on the signs of the compensation values may be added to a bitstream and then transmitted without transmitting the information on the absolute values of the compensation values used for the compensation of the prediction blocks.

In operation 440, a residual that is a difference value between the compensated prediction blocks of the macroblocks and the macroblocks of the current picture is transformed, quantized, and entropy encoded to generate a bitstream.

An apparatus for encoding an image according to a third exemplary embodiment of the present invention will now be explained. The apparatus according to the third exemplary embodiment of the present invention is similar in operation and configuration to the apparatus 300 of FIG. 3 according to the second exemplary embodiment of the present invention except that a difference between an average value of pixels included in a predictive picture of at least one previous picture and an average value of pixels included in an original previous picture is used as a compensation value when compensating a prediction block of a current block.

The compensation value calculation unit 320 of the apparatus generates a compensation value by calculating a difference value between an average value of pixels included in predictive pictures Pi of n previous pictures and an average value of pixels included in input previous pictures 0i.

The prediction block compensation unit 330 generates a positive compensation value +Δ by multiplying an absolute value Δ of the compensation value by +1 and generates a negative compensation value −Δ by multiplying the absolute value Δ of the compensation value by −1, and compensates prediction blocks of macroblocks by adding one of the positive compensation value and the negative compensation value to each pixel of the prediction block of each macroblock of the current picture. A process of encoding a residual that is a difference between the predictive picture of the current picture including the compensated prediction blocks and an original current picture is the same as that described with reference to the apparatus 300 of FIG. 3 according to the second exemplary embodiment of the present invention and thus a repeated explanation thereof will not be given. However, when information on the compensation value is added to a bitstream, since the original previous picture is used, it may be preferable that information on the absolute value of the compensation value be added to the bitstream.

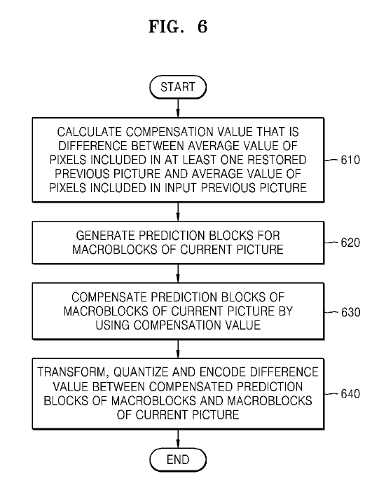

FIG. 6 is a flowchart illustrating a method of encoding an image according to a third exemplary embodiment of the present invention.

Referring to FIG. 6, in operation 610, a compensation value, that is a difference between an average value of pixels included in a restored previous picture that is obtained by encoding and restoring at least one previous picture and an average value of pixels included in an input previous picture, is calculated.

In operation 620, prediction blocks of macroblocks of a current picture are generated by performing intra-prediction or inter-prediction.

In operation 630, the prediction blocks of the macroblocks of the current picture are compensated by using the compensation value.

In operation 640, a difference value between the compensated prediction blocks of the macroblocks and the macroblocks of the current picture is transformed, quantized, and entropy encoded to generate a bitstream. Information on absolute values and signs of the compensation values used for the compensation of the prediction blocks are added to the generated bitstream.

An apparatus for encoding an image according to a fourth exemplary embodiment of the present invention will now be explained. The apparatus according to the fourth exemplary embodiment of the present invention has the same configuration as that of the apparatus 300 of FIG. 3 according to the second and third exemplary embodiments of the present invention. While the apparatus 300 of FIG. 3 according to the second and third exemplary embodiments of the present invention uses information on previous pictures of a current picture as a compensation value when compensating a prediction block of the current block, the apparatus according to the fourth exemplary embodiment uses a difference between an average value of pixels included in a restored current picture that is obtained by encoding and restoring a current picture and an average value of pixels included in an input current picture as a compensation value when compensating a prediction block of the current block.

To this end, the apparatus according to the fourth exemplary embodiment of the present invention encodes a current picture by using a conventional image compression method or the like, and restores the encoded current picture, and thereafter, uses a difference between an average value of pixel values included in the restored current picture and an average value of pixels included in an input current picture as a compensation value.

In detail, the prediction unit 310 generates prediction blocks for macroblocks of a current picture by performing inter-prediction or intra-prediction. A difference value between a generated prediction block and an input macroblock is transformed and quantized by the transformation and quantization unit 351, and inverse-quantized and inverse-transformed by the inverse-transformation and inverse-quantization unit 160 to be restored. The addition unit 370 adds the restored difference value and the prediction block to restore a current block. The process of restoring the current block is repeatedly performed on all blocks included in the current picture to generate a restored current picture that is encoded and then restored.

The compensation value calculation unit 320 calculates a compensation value that is a difference between an average value of pixels in the restored current picture and an average value of pixels in an input current picture.

The prediction block compensation unit 330 generates a positive compensation value +Δ by multiplying an absolute value Δ of the compensation value by +1, generates a negative compensation value −Δ by multiplying the absolute value Δ of the compensation value by −1, and then compensates for prediction blocks of macroblocks by adding one of the positive compensation value and the negative compensation value to each pixel of the prediction blocks of the current picture. A process of encoding a residual that is a difference between the predictive picture of the current picture including the compensated prediction blocks and an original current picture is the same as described above with reference to the apparatus 300 of FIG. 3 according to the second exemplary embodiment of the present invention, and thus a repeated explanation thereof will not be given.

As such, the apparatus according to the fourth exemplary embodiment of the present invention generates a restored current picture by encoding and restoring a current picture according to a conventional compression method, compensates for prediction blocks of macroblocks of a current picture by using a compensation value that is a difference between an average value of pixels included in the restored current picture and an average value of pixels included in an input current picture, and then encodes a residual that is a difference between the compensated prediction blocks and original input blocks.

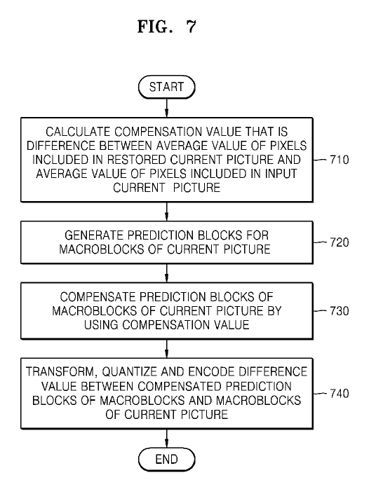

FIG. 7 is a flowchart illustrating a method of encoding an image according to the fourth exemplary embodiment of the present invention.

Referring to FIG. 7, in operation 710, a compensation value, that is a difference between an average value of pixels included in a restored current picture that is obtained by encoding and restoring a current picture and an average value of pixels included in an input current picture, is calculated. The restored current picture is a picture that is obtained by encoding and restoring a current picture according to one of various conventional compression methods.

In operation 720, prediction blocks for macroblocks of the current picture are generated by performing intra-prediction or inter-prediction. Without performing separate intra-prediction or inter-prediction, a predictive picture generated when the current picture is predicted according to the conventional compression method in operation 710 may be used.

In operation 730, the prediction blocks of the macroblocks of the current picture are compensated by using the compensation value.

In operation 740, a difference value between the compensated prediction blocks of the macroblocks and the macroblocks of the current picture is transformed, quantized, and entropy encoded to generate a bitstream. Information on an absolute value and a sign of the compensation value used for the compensation of the prediction block is added to the generated bitstream.

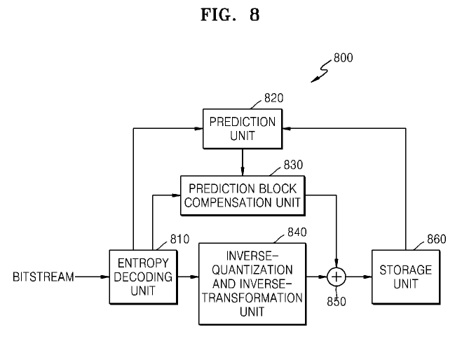

FIG. 8 is a block diagram of an apparatus 800 for decoding an image according to the first exemplary embodiment of the present invention.

Referring to FIG. 8, the apparatus 800 includes an entropy decoding unit 810, a prediction unit 820, a prediction block compensation unit 830, an inverse-quantization and inverse-transformation unit 840, an addition unit 850, and a storage unit 860.

The entropy decoding unit 810 receives a compressed bitstream and performs entropy decoding on the received bitstream to extract a prediction mode of a current block and information on an absolute value and a sign of a compensation value used when compensating a prediction block of the current block from the bitstream. The entropy decoding unit 810 also extracts from the bitstream a residual that is obtained by transforming, quantizing, and encoding a difference value between the compensated prediction block of the current block and an input current block.

The inverse-quantization and inverse-transformation unit 840 performs inverse-quantization and inverse-transformation on the residual of the current block to restore the residual.

The prediction unit 820 generates the prediction block of the current block according to the extracted prediction mode. For example, when the current block is an intra-predicted block, the prediction block of the current block is generated by using neighboring data of the same frame that is previously restored, and when the current block is an inter-predicted block, the prediction block of the current block is acquired from a reference picture by using information on a motion vector and the reference picture included in the bitstream.

The prediction block compensation unit 830 selects a compensation value used for the compensation of the prediction block of the current block from among a positive compensation value obtained by multiplying the absolute value of the compensation value by +1 and a negative compensation value obtained by multiplying the absolute value of the compensation value by −1 by using the information on the absolute value and sign extracted from the bitstream. The prediction block compensation unit 830 compensates the prediction block by adding the selected compensation value to each pixel of the prediction block output from the prediction unit 820.

The addition unit 850 restores the current block by adding the compensated prediction block and the restored residual. The restored current block is stored in the storage unit 860, and is used to predict a next block and calculate a compensation value.

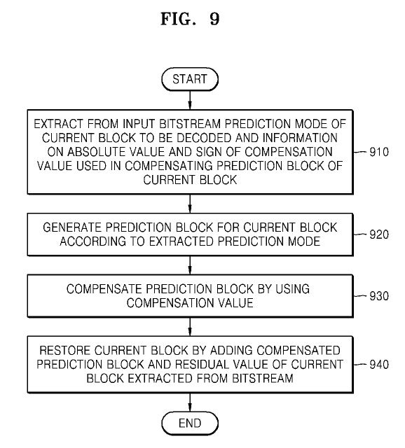

FIG. 9 is a flowchart illustrating a method of decoding an image according to the first exemplary embodiment of the present invention.

Referring to FIG. 9, in operation 910, a prediction mode of a current block to be decoded and information on an absolute value and a sign of a compensation value used when compensating a prediction block of the current block are extracted from an input bitstream.

In operation 920, the prediction block of the current block is generated according to the extracted prediction mode.

In operation 930, the prediction block is compensated by using the compensation value. In detail, a compensation value used in the compensation of the prediction block of the current block is selected from among a positive compensation value obtained by multiplying the absolute value of the compensation value by +1 and a negative compensation value obtained by multiplying the absolute value of the compensation value by −1 by using the information on the absolute value and the sign of the compensation value extracted from the bitstream, and the prediction block is compensated by adding the selected compensation value to each pixel of the prediction block.

In operation 940, the current block is restored by adding the compensated prediction block and a residual value of the current block extracted from the bitstream.

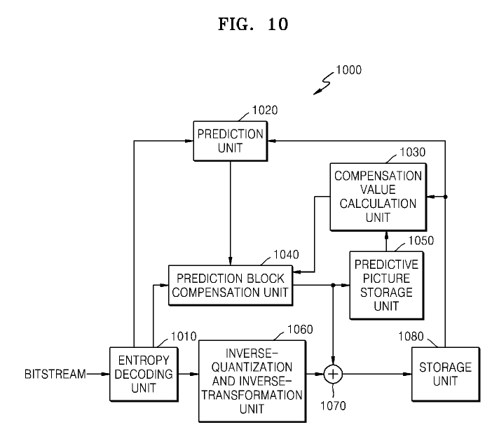

FIG. 10 is a block diagram of an apparatus 1000 for decoding an image according to the second exemplary embodiment of the present invention. When transmitting only information on a sign of a compensation value without transmitting information on an absolute value of the compensation value, the apparatus 1000 of FIG. 10 according to the second exemplary embodiment of the present invention generates the compensation value by performing the same operations as those performed by the apparatus 300 of FIG. 3 according to the second exemplary embodiment of the present invention. The apparatus 1000 of FIG. 10 generates the compensation value for each of a plurality of pictures, and applies the compensation value to macroblocks in the picture.

Referring to FIG. 10, the apparatus 1000 includes an entropy decoding unit 1010, a prediction unit 1020, a compensation value calculation unit 1030, a prediction block compensation unit 1040, a predictive picture storage unit 1050, an inverse-quantization and inverse-transformation unit 1060, an addition unit 1070, and a storage unit 1080.

The entropy decoding unit 1010 receives a compressed bitstream and performs entropy decoding on the received bitstream to extract a prediction mode of macroblocks included in a current picture to be decoded and information on a sign of a compensation value used when compensating prediction blocks from the bitstream. The entropy decoding unit 1010 extracts a residual that is obtained by transforming and quantizing a difference value between the compensated prediction block and an input current macroblock from the bitstream.

The inverse-quantization and inverse-transformation unit 1060 performs inverse-quantization and inverse-transformation on the residual of the current macroblock to restore the residual.

The prediction unit 1020 generates the prediction block of the current macroblock according to the extracted prediction mode.

The compensation value calculation unit 1030 calculates a compensation value by using a difference between an average value of pixels included in a predictive picture of at least one previous picture that is restored before the current picture and an average value of pixels included in a restored previous picture.

The prediction block compensation unit 1040 selects a compensation value to be used when compensating the prediction block of the macroblock included in the current picture, from among a positive compensation value obtained by multiplying an absolute value of the compensation value by +1 and a negative compensation value obtained by multiplying the absolute value of the compensation value by −1, by using the information on the sign of the compensation value extracted from the bitstream. For example, the prediction block compensation unit 1040 selects a compensation value to be used when compensating the prediction block of each macroblock of the current picture by using the information on the sign indicating whether the prediction block of the macroblock in the current picture is compensated by using the positive compensation value or the negative compensation value, and compensates the prediction block of the macroblock by adding the selected compensation value to each pixel in the prediction block of the macroblock. The predictive picture generated as a result of this compensation is stored in the predictive picture storage unit 1050 in order to calculate a compensation value of a next picture.

The addition unit 1070 restores the macroblocks of the current picture by adding the compensated prediction blocks of the macroblocks and the residual included in the bitstream. The restored current picture is stored in the storage unit 1080 in order to predict a next picture and calculate a compensation value of the next picture.

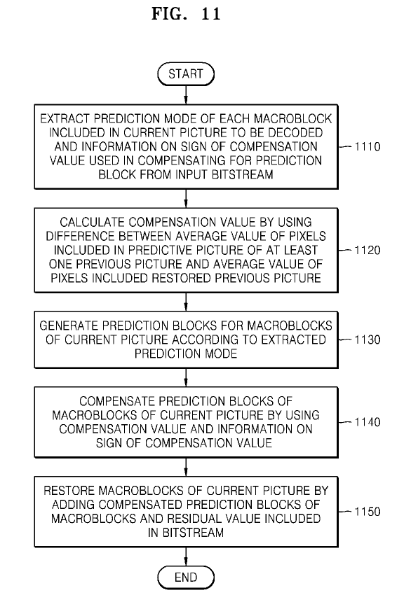

FIG. 11 is a flowchart illustrating a method of decoding an image according to the second exemplary embodiment of the present invention.

Referring to FIG. 11, in operation 1110, a prediction mode of each macroblock included in a current picture to be decoded and information on a sign of a compensation value used when compensating a prediction block of the macroblock are extracted from an input bitstream.

In operation 1120, a compensation value is calculated by using a difference between an average value of pixels included in a predictive picture of at least one previous picture that is restored before a current picture and an average value of pixels included in a restored previous picture.

In operation 1130, prediction blocks of macroblocks of the current picture are generated according to the extracted prediction mode.

In operation 1140, it is determined whether a positive compensation value or a negative compensation value is applied to each of the prediction blocks of the macroblocks of the current picture by using the calculated compensation value and the information on the sign of the extracted compensation value, and the prediction blocks are compensated by adding the determined compensation value to pixels of the prediction blocks of the macroblocks.

In operation 1150, the macroblocks of the current picture are restored by adding the compensated prediction blocks of the macroblocks and the residual value that was extracted from the bitstream and restored.

As described above, since redundancy present in a prediction block is additionally removed, compression efficiency and a PSNR can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims. The present invention may be embodied as computer-readable codes on a computer-readable recording medium. The computer-readable recording medium is any data storage device that can store data which can be thereafter read by a computer system. Examples of the computer-readable recording medium include read-only memories (ROMs), random-access memories (RAMs), CD-ROMs, magnetic tapes, floppy disks, and optical data storage devices. The computer-readable recording medium can also be distributed over network coupled computer systems so that the compute readable code is stored and executed in a distributed fashion.

What is claimed is:

1. A method of encoding an image, the method comprising:
generating a prediction block for a current block;
calculating a compensation value that is a difference between an average value of pixels in the current block and an average value of pixels in the prediction block;
compensating the prediction block using the compensation value; and
encoding a difference value that is a difference between the compensated prediction block and the current block.

2. The method of claim 1, wherein the compensating the prediction block comprises:
generating a positive compensation value by multiplying an absolute value of the compensation value by +1;
generating a negative compensation value by multiplying the absolute value by −1; and
compensating the prediction block by adding one of the positive compensation value and the negative compensation value to each pixel of the prediction block.

3. The method of claim 1, wherein the encoding comprises adding information on an absolute value of the compensation value and information on a sign of the compensation value to a bitstream generated by the encoding.

4. An apparatus for encoding an image, the apparatus comprising:
a prediction unit which generates a prediction block for a current block;
a compensation value calculation unit which calculates a compensation value that is a difference between an average value of pixels in the current block and an average value of pixels in the prediction block;
a prediction block compensation unit which compensates the prediction block using the compensation value; and
an encoding unit which encodes a difference value that is a difference between the compensated prediction block and the current block.

5. The apparatus of claim 4, wherein the prediction block compensation unit generates a positive compensation value by multiplying an absolute value of the compensation value by +1, generates a negative value by multiplying the absolute value of the compensation value by −1, and compensates the prediction block by adding one of the positive compensation value and the negative compensation value to each pixel of the prediction block.

6. The apparatus of claim 4, wherein the encoding unit adds information on an absolute value of the compensation value and information on a sign of the compensation value to a bitstream generated by the encoding.

7. A method of encoding an image, the method comprising:
calculating a compensation value that is a difference between an average value of pixels included in a predictive picture of at least one previous picture and an average value of pixels included in a restored previous picture that is obtained by encoding and restoring the previous picture;
generating prediction blocks for macroblocks of a current picture;
compensating the prediction blocks of the macroblocks of the current picture using the compensation value; and
encoding a difference value that is a difference between the compensated prediction blocks of the macroblocks of the current picture and the macroblocks of the current picture.

8. The method of claim 7, wherein the compensating the prediction blocks of the macroblocks of the current picture comprises:
generating a positive compensation value by multiplying an absolute value of the compensation value by +1;
generating a negative compensation value by multiplying the absolute value of the compensation value by −1; and
compensating the macroblocks of the current picture by adding one of the positive compensation value and the negative compensation value to each pixel of each of the macroblocks of the current picture.

9. The method of claim 7, further comprising adding information on whether a prediction block is compensated and information on a sign of the compensation value to a bitstream generated by the encoding.

10. An apparatus for encoding an image, the apparatus comprising:
a predictive picture storage unit which stores a predictive picture of at least one previous picture;
a restored picture storage unit which stores a restored picture that is obtained by encoding and restoring each picture included in an input image;
a compensation value calculation unit which calculates a compensation value that is a difference between an average value of pixels included in the previous picture and an average value of pixels included in a restored previous picture that is obtained by encoding and restoring the previous picture;
a prediction unit which generates prediction blocks for macroblocks of a current picture;
a prediction block compensation unit which compensates the prediction blocks of the macroblocks of the current picture using the compensation value; and
an encoding unit which encodes a difference value between the compensated prediction blocks of the macroblocks of the current picture and the macroblocks of the current picture.

11. The apparatus of claim 10, wherein the prediction block compensation unit generates a positive compensation value by multiplying an absolute value of the compensation value by +1, generates a negative compensation value by multiplying the absolute value of the compensation value by −1, and compensates the macroblocks of the current picture by adding one of the positive compensation value and the negative compensation value to each pixel of each of the macroblocks of the current picture.

12. The apparatus of claim 10, wherein the encoding unit adds information on whether a prediction block is compensated and information on a sign of the compensation value to a bitstream generated by the encoding.

13. A method of encoding an image, the method comprising:
calculating a compensation value that is a difference between an average value of pixels included in a restored previous picture that is obtained by encoding and restoring at least one previous picture and an average value of pixels included in the previous picture;
generating prediction blocks of macroblocks of a current picture;
compensating the prediction blocks of the macroblocks of the current picture using the compensation value; and
encoding a difference value that is a difference between the compensated prediction blocks of the macroblocks of the current picture and the macroblocks of the current picture.

14. The method of claim 13, wherein the compensating the prediction blocks of the macroblocks of the current picture comprises:
generating a positive compensation value by multiplying an absolute value of the compensation value by +1;
generating a negative compensation value by multiplying the absolute value of the compensation value by −1; and
compensating the macroblocks by adding one of the positive compensation value and the negative compensation value to each pixel of each of the macroblocks of the current picture.

15. The method of claim 13, further comprising adding information on an absolute value of the compensation value and information on a sign of the compensation value to a bitstream generated by the encoding.

16. An apparatus for encoding an image, the apparatus comprising:
a restored picture storage unit which stores a restored picture that is obtained by encoding and restoring each picture included in an input image;
a compensation value calculation unit which calculates a compensation value that is a difference between an average value of pixels included in at least one restored previous picture and an average value of pixels included in a previous picture;
a prediction unit which generates prediction blocks for macroblocks of a current picture;
a prediction block compensation unit which compensates the prediction blocks of the macroblocks of the current picture using the compensation value; and
an encoding unit which encodes a difference value that is a difference between the compensated prediction blocks of the macroblocks of the current picture and the macroblocks of the current picture.

17. The apparatus of claim 16, wherein the prediction block compensation unit generates a positive compensation value by multiplying an absolute value of the compensation value by +1, generates a negative compensation value by multiplying the absolute value of the compensation value by −1, and compensates the macroblocks by adding one of the positive compensation value and the negative compensation value to each pixel of each of the macroblocks of the current picture.

18. The apparatus of claim 16, wherein the encoding unit adds information on an absolute value of the compensation value and information on a sign of the compensation value to a bitstream generated by the encoding.

19. A method of encoding an image, the method comprising:
calculating a compensation value that is a difference between an average value of pixels included in a restored current picture that is obtained by encoding and restoring a current picture and an average value of pixels included in the current picture;
generating prediction blocks for macroblocks of the current picture;
compensating the prediction blocks of the macroblocks of the current picture using the compensation value; and
encoding a difference value that is a difference between the compensated prediction blocks of the macroblocks of the current picture and the macroblocks of the current picture.

20. The method of claim 19, wherein the compensating the prediction blocks of the macroblocks of the current picture comprises:
generating a positive compensation value by multiplying an absolute value of the compensation value by +1;
generating a negative compensation value by multiplying the absolute value of the compensation value by −1; and
compensating the macroblocks by adding one of the positive compensation value and the negative compensation value to each pixel of each of the macroblocks of the current picture.

21. The method of claim 19, further comprising adding information on an absolute value of the compensation value and information on a sign of the compensation value to a bitstream generated by the encoding.

22. An apparatus for encoding an image, the apparatus comprising:
a prediction unit which generates prediction blocks for macroblocks of a current picture;
an encoding unit which encodes a difference value that is a difference between each of the prediction blocks and an input macroblock;
a restoration unit which restores the current picture;
a compensation value calculation unit which calculates a compensation value that is a difference between an average value of pixels included in the restored current picture and an average value of pixels included in the current picture; and
a prediction block compensation unit which compensates the prediction blocks of the macroblocks of the current picture using the compensation value,
wherein the encoding unit encodes a difference value that is a difference between the compensated prediction blocks of the macroblocks of the current picture and the macroblocks of the current picture to generate a final bitstream.

23. The apparatus of claim 22, wherein the prediction block compensation unit generates a positive compensation value by multiplying an absolute value of the compensation value by +1, generates a negative compensation value by multiplying the absolute value of the compensation value by −1, and compensates the macroblocks by adding one of the positive compensation value and the negative compensation value to each pixel of each of the macroblocks of the current picture.

24. The apparatus of claim 22, wherein the encoding unit adds information on an absolute value of the compensation value and information on a sign of the compensation value to the final bitstream generated by the encoding.

25. A method of decoding an image, the method comprising:
extracting from an input bitstream a prediction mode of a current block to be decoded and information on an absolute value and a sign of a compensation value used to compensate a prediction block of the current block;
generating the prediction block of the current block according to the extracted prediction mode;
compensating the prediction block using the compensation value; and
restoring the current block by adding the compensated prediction block and a residual value of the current block which is extracted from the bitstream.

26. The method of claim 25, wherein the compensating the prediction block comprises:
selecting a compensation value used for the compensating the prediction block of the current block, from among a positive compensation value obtained by multiplying the absolute value of the compensation value by +1 and a negative compensation value obtained by multiplying the absolute value of the compensation value by −1, based on the extracted information on the absolute value and the sign of the compensation value; and
compensating the prediction block by adding the selected compensation value to each pixel of the prediction block.

27. The method of claim 25, wherein the compensation value is a difference value that is a difference between an average value of pixels of the current block and an average value of pixels of the prediction block of the current block.

28. The method of claim 25, wherein the compensation value is a difference value that is a difference between an average value of pixels included in at least one previous picture, which is decoded before a current picture to which the current block belongs, and an average value of pixels included in an original previous picture corresponding to the at least one previous picture.

29. An apparatus for decoding an image, the apparatus comprising:
an entropy decoding unit which extracts from an input bitstream a prediction mode of a current block to be decoded and information on an absolute value and a sign of a compensation value used to compensate a prediction block of the current block;
a prediction unit which generates the prediction block of the current block according to the extracted prediction mode;
a prediction block compensation unit which compensates the prediction block using the compensation value; and
an addition unit which restores the current block by adding the compensated prediction block and a residual value of the current block which is extracted from the bitstream.

30. The apparatus of claim 29, wherein the prediction block compensation unit selects a compensation value used for compensating the prediction block of the current block, from among a positive compensation value obtained by multiplying the absolute value of the compensation value by +1 and a negative compensation value obtained by multiplying the absolute value of the compensation value by −1, based on the extracted information on the absolute value and the sign of the compensation value, and compensates the prediction block by adding the selected compensation value to each pixel of the prediction block.

31. A method of decoding an image, the method comprising:
extracting from an input bitstream a prediction mode of each macroblock included in a current picture to be decoded and information on a sign of a compensation value used to compensate a prediction block of the macroblock;
calculating the compensation value using a difference between an average value of pixels included in a predictive picture of at least one previous picture that is restored before the current picture and an average value of pixels included in a restored previous picture;
generating prediction blocks of macroblocks of the current picture according to the extracted prediction mode;
compensating the prediction blocks of the macroblocks of the current picture using the compensation value and the information on the sign of the compensation value; and
restoring the macroblocks of the current picture by adding the compensated prediction blocks of the macroblocks and a residual value included in the bitstream.

32. The method of claim 31, wherein the compensating the prediction blocks comprises:
selecting a compensation value used for the compensation of each of the prediction blocks of the current block, from among a positive compensation value obtained by multiplying the absolute value of the compensation value by +1 and a negative compensation value obtained by multiplying the absolute value of the compensation value by −1, based on the extracted information on the absolute value and the sign of the compensation value; and
compensating the prediction block by adding the selected compensation value to each pixel of the prediction block.

33. An apparatus for decoding an image, the apparatus comprising:
an entropy decoding unit which extracts from an input bitstream a prediction mode of each macroblock included in a current picture to be decoded and information on a sign of a compensation value used to compensate a prediction block of the macroblock;
a compensation value calculation unit which calculates the compensation value using a difference between an average value of pixels included in a predictive picture of at least one previous picture that is restored before the current picture and an average value of pixels included in a restored previous picture;
a prediction unit which generates prediction blocks for macroblocks of the current picture according to the extracted prediction mode;
a prediction block compensation unit which compensates the prediction blocks of the macroblocks of the current picture using the compensation value and the information on the sign of the compensation value; and
an addition unit which restores the macroblocks of the current picture by adding the compensated prediction blocks of the macroblocks and a residual value included in the bitstream.

34. The apparatus of claim 33, wherein the prediction block compensation unit selects a compensation value used for the compensation of each of the prediction blocks of the current block, from among a positive compensation value obtained by multiplying the absolute value of the compensation value by +1 and a negative compensation value obtained by multiplying the absolute value of the compensation value by −1, based on the extracted information on the absolute value and the sign of the compensation value, and compensates the prediction block by adding the selected compensation value to each pixel of the prediction block.
